(19) United States
(12) Patent Application Publication
(10) Pub. No.: US 2014/0273824 A1
(43) Pub. Date: Sep. 18, 2014

(54) SYSTEMS, APPARATUS AND METHODS FACILITATING SECURE PAIRING OF AN IMPLANTABLE DEVICE WITH A REMOTE DEVICE USING NEAR FIELD COMMUNICATION

(71) Applicant: MEDTRONIC, INC., Minneapolis, MN (US)

(72) Inventors: Andreas Fenner, Chandler, AZ (US); Mohsen Askarinya, Chandler, AZ (US); Jeffrey York, Mesa, AZ (US)

(73) Assignee: MEDTRONIC, INC., Minneapolis, MN (US)

(21) Appl. No.: 13/837,554

(22) Filed: Mar. 15, 2013

(51) Int. Cl. H04B 5/00

(52) U.S. Cl. CPC H04B 5/0031
USPC 455/41.1

(57) ABSTRACT

Systems, apparatus and methods configured to facilitate pairing an implantable device with a remote device using a near field communication (NFC) device attached to the implantable device are presented. In an aspect, an implantable device assembly includes an implantable device and an NFC component externally attached to the implantable device. The NFC component is configured to transmit identification information associated with the implantable device to a reader device using NFC protocol. Transmission is in response to a received request signal.

### TECHNICAL FIELD

This disclosure relates generally to implantable devices and, more particularly, to systems, apparatus and methods facilitating secure pairing of implantable devices with remote devices using near field communication (NFC).

### BACKGROUND

Many implantable devices, such as implantable medical devices, are configured to communicate information with an external device using various wireless communication techniques. Oftentimes, the information communicated between the implantable device and the external device is sensitive or personal information. For example, an implantable medical device, such as a pacemaker, can communicate confidential information relating to a patient's heart condition to an external device. In another example, a control device can wirelessly program an implanted medical device to perform functions prescribed for patient treatment. However, measures for ensuring secure and trusted communication of information between an implantable medical device and an external device using mainstream wireless communication techniques are limited.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with pairing an implantable device with a remote device using an NFC tag attached to the implantable device. In an embodiment, an implantable medical device assembly includes an implantable medical device and an NFC component externally attached to the implantable medical device. The NFC component is configured to transmit identification information associated with the implantable medical device to a reader device using NFC protocol, wherein transmission is in response to a received request signal. In an aspect, the implantable device is configured to pair with the reader device based, in part, on transmission of the identification information by the NFC component. The NFC component can be encased in a biocompatible housing and include an integrated circuit, an antenna, memory storing the identification information, and, optionally, a ferrite shield.

In another embodiment, an apparatus is presented that includes a biocompatible housing coupleable to an implantable medical device and an integrated circuit disposed within the biocompatible housing. The integrated circuit includes at least a computer-readable storage medium configured to store identification information associated with the implantable medical device and an antenna configured to transmit the identification information to a reader device using near field communication NFC protocol in response to a request signal.

In one or more additional aspects, a method is disclosed that includes employing at least one processor executing computer-executable instructions embodied on at least one computer-readable storage medium to perform the following operations: receiving, at a near field communication NFC component attached to an implantable device, a request to pair a remote device with the implantable device, and transmitting by the NFC component, identification information associated with the implantable device to the remote device in response to the request using NFC protocol

Further disclosed is an external device, such as a reader/programmer device, configured to wirelessly communicate with an implantable device. The device can include, a near field communication component NFC configured to transmit a request to pair with an implantable device using a first communication protocol and receive identification information associated with the implantable device in response to the request, wherein the first communication protocol includes an NFC protocol, and an authorization component configured to determine if the device is authorized to pair with the implantable device based in part on the identification information. The device further includes a primary communication component configured to communicate with the implantable device using a second communication protocol different from the first communication protocol in response to a determination that the device is authorized to pair with the implantable device.

In yet another embodiment, a method is presented that includes transmitting a request to pair with an implantable device using a first communication protocol, wherein the first communication protocol includes an NFC protocol. The method further includes receiving identification information associated with the implantable device in response to the request and determining if the device is authorized to pair with the implantable device based in part on the identification information. In response to a determination that the device is authorized to pair with the implantable device, the method provides for communicating with the implantable device using a second communication protocol different from the first communication protocol.

Other embodiments and various non-limiting examples, scenarios and implementations are described in more detail below. The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 presents a system for pairing an implantable device with an external device using an NFC device attached to the implantable device in accordance with various aspects and embodiments described herein.

FIG. 2 illustrates a diagram demonstrating an example pairing process between a remote device and an implantable device in accordance with various aspects and embodiments described herein.

FIG. 3 presents an example embodiment of an NFC device configured to attach to an implantable device in accordance with an aspect of the disclosed subject matter.

FIG. 4 presents an example embodiment of an implantable device assembly configured to be implanted into a body in accordance with an aspect of the disclosed subject matter.

FIG. 5 presents another example embodiment of an implantable device assembly configured to be implanted into a body in accordance with an aspect of the disclosed subject matter.

FIG. 6 presents another example embodiment of an implantable device assembly configured to be implanted into a body in accordance with an aspect of the disclosed subject matter.

FIG. 7 presents another example embodiment of an implantable device assembly configured to be implanted into a body in accordance with an aspect of the disclosed subject matter.

FIG. 8 presents an example embodiment of an implantable device capable of pairing with a remote device using an NFC tag associated with the implantable device in accordance with an aspect of the disclosed subject matter

FIG. 9 presents an example embodiment of a remote device capable of pairing with an implantable device using an NFC tag associated with the implantable device in accordance with an aspect of the disclosed subject matter.

FIG. 10 is a flow diagram of an example method for pairing an implantable device with a remote device using an NFC tag associated with the implantable device in accordance with an aspect of the disclosed subject matter.

FIG. 11 is a flow diagram of another example method for pairing an implantable device with a remote device using an NFC tag associated with the implantable device in accordance with an aspect of the disclosed subject matter.

FIG. 12 is a flow diagram of another example method for pairing an implantable device with a remote device using an NFC tag associated with the implantable device in accordance with an aspect of the disclosed subject matter.

FIG. 13 illustrates a block diagram of a computer operable to facilitate pairing an implantable device and a remote device in accordance with embodiments described herein.

### DETAILED DESCRIPTION

The following detailed description is merely illustrative and is not intended to limit embodiments or application and uses of embodiments. Furthermore, there is no intention to be bound by any expressed or implied theory presented in the preceding Technical Field, Background or Summary sections, or in the following Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the various embodiments. It is evident, however, that the various embodiments can be practiced without these specific details.

Additionally, the following description refers to components being “connected,” “coupled,” “attached” and/or “adjoined” to one another. As used herein, unless expressly stated otherwise, the terms “connected,” “coupled,” “attached” and/or “adjoined” mean that one component is directly or indirectly connected to another component, mechanically, electrically or otherwise. Thus, although the figures may depict example arrangements of components, additional and/or intervening components may be present in one or more embodiments.

With reference now to the drawings, FIG. 1 presents system 100 for pairing an implantable device with an external device using an NFC device attached to the implantable device. System 100 includes implantable device 108 implanted within the human body, NFC device 110 attached to implantable device 108, remote device 106 and server 102. In various aspects, implantable device 108, NFC device 110, remote device 106 and/or server 102 are configured to communicate with one another over one or more networks 104.

System 100 facilitates pairing implantable device 108 and remote device 106 prior to enabling communication of secure information between implantable device 108 and server 102 and/or implantable device 108 and remote device 106. As used herein, the term “pairing” relates to the process of setting up a secure association between two devices. In an aspect, system 100 employs NFC device 110 attached to implantable device 108 to facilitate transmitting and/or receiving information using NFC protocol in associating with pairing implantable device 108 and remote device 106.

In an aspect, NFC device 110 transmits identification information to remote device 106. This identification information is then employed to authenticate implantable device 108 and facilitate authorization of data exchange between implantable device 108 and server 102 and/or implantable device 108 and remote device 106. In response to the authorization, remote device 106 and implantable device 108 can establish a secure and authorized communication channel, thus becoming “paired.” In an aspect, remote device 106 and implantable device 108 can exchange secure, private, or otherwise protected information between one another only after becoming paired. The identification information may include any information that functions as authentication information assigned to implantable device 108. For example, the identification information transmitted by NFC device 110 may include a secure password, private key, a device identifier (e.g., a serial number or other information assigned to implantable device 108).

System 100 can employ various pairing protocols to facilitate setting up a secure channel between remote device 106 and implantable device 108 and/or remote device 106 and server 102 based in part on identification information provided by NFC device 110. The secure channel provides for confidentiality, integrity and authenticity of the data transferred between devices. In one embodiment, remote device 106 functions as proxy for setting up a secure data channel between implantable device 108 and an external server 102. In additional embodiments, the remote device 106 can function as a reader/programmer device for implantable device 108 and pair with the implantable device 108 without employing an external server 102.

With respect to the first embodiment, system 100 can employ external server 102 to facilitate the pairing process between remote device 106 and implantable device 108. According to this embodiment, remote device 106 functions as a proxy device for establishing a secure data exchange channel between implantable device 108 and server 102. Server 102 can include one or more suitable interconnected computing devices that have authorization and authentication capabilities. In an aspect, server 102 is a data server and stores information related to one or more implanted devices (e.g., device 108). Server 102 can include one or more processing systems that facilitate reading and interpreting information provided by and implantable device (e.g., implantable device 108). Server 102 can further include capability of issuing control commands (e.g., programming commands) to implantable device 108 over the secure data channel established between server 102, remote device 106 and implantable device based 108 in part on identification information transmitted by the NFC device to remote device 106.

The server 102 can employ various authorization/authentication methods to facilitate pairing with the implantable device 108 via remote device 106. In an aspect, NFC device 110 can transfer identification information that uniquely identifies implantable device 108 to remote device 106. The remote device 106 can further compare the identification information received from the NFC device 110 with identification associated with other communication protocols employed by the remote device to communicate with the implantable device (e.g., BLUETOOTH® low energy (BTLE) protocol). Where the identification information received from the NFC device 110 indicates that an authorized pairing is required between the remote device 106 and the implantable device 108 prior to allowing communication between the remote device 106 and the implantable device 108, the remote device 106 can employ server 102 to facilitate authorizing pairing between the remote device 106 and the implantable device 108. In particular, the server 102 can establish a pairing between the implantable device 108 and the server 102 using the remote device 106 merely to establish a tunnel between the implantable device 108 and the server 102.

According to this embodiment, in order to pair remote device 106 and implantable device 108, the remote device 106 can be brought within close proximity to NFC device 110. At this time, an NFC component of the remote device 106 energizes an induction coil of the NFC device 110. This transfer of energy causes the NFC device 110 to transfer identification information, (e.g., a key or password) stored therein to the remote device 106 using NFC protocol. The remote device 106 can then pass this identification information received from NFC device 110 to server 102. Server 102 can in turn employ the identification information to authenticate implantable device 108 and remote device 106 and authorize pairing between the two devices.

For example, in order to pair remote device 106 and implantable device 108, server 102 can pass a message to the remote device 106 (e.g., a key or password) indicting that the remote device 106 is authorized to pair with the implantable device 108 for the purpose of setting up a secure data communications channel between the implantable device 108 and the server 102. The pairing between the remote device 106 and the implantable device 108 is then effectuated using the message sent from the server 102. For example, where the message is a private key, the remote device 106 and/or the implantable device can employ the private key and another key stored at the respective devices to perform a key matching procedure. In another example, the remote device 106 can communicate a message to implantable device 108 that indicates the two devices have been authorized to communicate, where authorization is received based in part on the identification information transferred by NFC device 110 to remote device 106. Upon receipt of the message by implantable device 108, implantable device 108 and server 102 can begin secure communication using remote device 106 as a proxy.

In an aspect, the message transmitted from the server 102 to the implantable device 108 via remote device 106 can restrict the type of information exchange that has been authorized. For example, the message can indicate and thus authorize secure data transfer from implantable device 108 to remote device 106 yet deny data transfer from remote device 106 to implantable device 108. In another example, the message can indicate and thus authorize data transfer of a first set of information (e.g., information rated as mildly sensitive) yet deny data transfer of a second set of information (e.g., information rated as highly sensitive).

According to this embodiment, data transferred between the implantable device 108 and the remote device 106 is not displayed at the remote device 106. On the contrary, the server 102 receives, processes and displays information communicated to and from the implantable device 108. In an aspect, the only way the remote device 106 would then be authorized to view and/or program information on implantable device 108 would be if it were authorized by server 102. This could be accomplished by entering user information associated with an account on the remote device 106 in response to a request by the remote device to communicate with the implantable device 108. Therefore, the remote device 106 would be paired directly with server 102 and indirectly with the implantable device 108.

Identification information for remote device 106 and/or implantable device 108 can include but is not limited to: a code, password, personal identification number (PIN) or ID number. In another aspect, identification information can includes a digital certificate assigned to implantable device 108 or remote device 106. In yet another aspect, the identification information can include private keys and/or public keys associated with a public key infrastructure (PKI). In particular, the identification information for implantable device 108 can include a secret or private key associated with the implantable device and required for user authorization in association with a public key.

In an aspect, server 102 employs a PKI infrastructure to facilitate authenticating and authorizing pairing between remote device 106 and implantable device 108 based on received identification information for the implantable device 108 (as received from NFC device 110) and the remote device 106. PKI is a standard basis for digital signatures (e.g. standard electronic signatures). PKI provides each party in an authentication agreement with a pair of keys, a private key, and a public key, used in every signed transaction. The private key, as the name implies, is not shared and is used only by a single authorizing device (e.g., NFC device 110). The public key is openly available and used by the entity that needs to validate the private key. In another aspect, server 102 can employ a standard cryptographic key exchange agreement protocol (e.g., Diffie-Hellman), to facilitate setting up a secure channel between implantable device 108 and remote device 106. According to this aspect, the identification information stored and transmitted by NFC device 110 can include a key assigned to implantable device 108 that can be used to authenticate implantable device 108 in association with a key agreement protocol.

In various additional embodiments, system 100 can facilitate pairing between the remote device 106 and the implantable device 108 without use of an external server 102. According to these embodiments, remote device 106 can function as a reader/programmer device and for implantable device 108. In particular, remote device 106 can establish a secure communication channel with implantable device 108, or the implantable device 108 can establish a secure channel with the remote device 106, using identification information transferred to the remote device 106 via NFC device 110 without employing an external server 102. After establishment of the secure communication channel, the remote device 106 can view and/or process data received from implantable device 108 and/or program implantable device 108.

For example, in one additional embodiment, the remote device 106 is configured to perform authenticating/authorization of the implantable device 108. In particular, the remote device 106 can employ techniques to authenticate and authorize a pairing between the remote device 106 and implantable device 108 without communication to an external server 102 (e.g., where network 104 for communicating to a server 102 is not available) based in part on identification information for the implantable device 108 received via NFC device 110.

According to this embodiment, remote device 106 can include an authentication/authorization system configured to authenticate and authorize pairing between remote device 106 and implantable device 108. The remote device 106 can employ any suitable techniques to authenticate implantable device 108 for pairing therewith. In an aspect, the remote device 106 first receives identification information for the implantable device 108 via NFC device 110 when brought within proximity to NFC device 110. The remote device 106 can then compare the identification information with information stored at the remote device 106 indicating whether the identification information can authorize pairing with the implantable device 108 (e.g., the remote device 106 can perform a key matching procedure). Once the remote device 106 authenticates the implantable device using the identification information, the remote device can establish a secure channel with the implantable device 108.

In accordance with this embodiment, a user/patient 112 in which implantable device/NFC device assembly is implanted can provide remote device 106 with authentication information to facilitate the pairing between remote device 106 and implantable device 108. In this manner, system 100 can prevent every single device employing NFC capabilities from communicating with NFC device 110. For example, the user 112 can provide remote device 106 with an authentication code/password associated with the device implantable device 108. This authentication code/password could be provided by the user verbally, manually input by the user 112 or an operator of the remote device 106, provided by the user 112 to the remote device as a readable card (e.g., a smart card or NFC thumbtag), and etc. According to this aspect, the remote device 106 would first be authorized/authenticated to communicate with the NFC device 110 based on the authentication code/password provided thereto by the user 112.

In another aspect, an operator of remote device 106 can provide remote device 106 with authentication/authorization information to facilitate pairing between remote device 106 and implantable device 108 in the alternative to or in addition to information provided by user 112. For example, where implantable device 108 is a medical device, a doctor operating remote device 106 can enter/provide remote device 106 with a code/password required by remote device 106 prior to allowing communication with NFC device 110 to facilitate pairing of remote device 106 with implantable device 108.

In an additional embodiment, the implantable device 108 is configured to authenticate remote device 106 without employing external server 102. According to this embodiment, the implantable device 108 and/or the NFC device 110 can authenticate the remote device 106 based in part on identification information transferred from the remote device 106 to the NFC device 110. For example, the remote device 106 can include identification information (e.g., a key, a serial number, a password, a digital certificate) that remote device 106 can transfer to NFC device 110 using NFC protocol. NFC device 110 and/or implantable device 108 can employ the identification information for remote device 106 to authenticate remote device 106 and authorize a secure pairing between remote device 106 and implantable device 108.

In an aspect, NFC device 110 can include a processor configured to process identification information received from remote device 106. According to this aspect, upon receipt of identification information from remote device 106, NFC device 110 can authenticate remote device 110 based on the identification information and generate an authorization message (e.g., a private key, password) indicating that implantable device 108 authorizes pairing with remote device 106. NFC device 110 can further transmit the authorization message back to remote device 106 using NFC protocol. Remote device 106 can then transmit the authorization message to implantable device 108 (e.g., using BLUETOOTH® protocol) and implantable device 108 can set up a secure communication channel with remote device 106 in response to receipt of the authorization message.

In another aspect, NFC device 110 can be configured to communicate with implantable device 108 to facilitate pairing implantable device 108 with remote device 106 based on identification information for remote device 106 received at NFC device 110. According to this aspect, NFC device 110 can be configured to communicate with implantable device 108 wirelessly or via one or more wires connecting a circuit of NFC device 110 to a circuit of implantable device 108. For example, an antenna of NFC device 110 can be configured to communicate with an antenna of implantable device 108 using NFC protocol or RF telemetry techniques.

In accordance with this aspect, NFC device 110 can either process received identification information from remote device 106 or transmit the identification information to implantable device 108 for processing thereof. For example, upon receipt of identification information for remote device 106, NFC device 110 can authenticate remote device 106 based on the identification information and generate a message indicating that the implantable device is authorized to pair with remote device 106. NFC device 110 can then transmit this message to implantable device 108. Upon receipt of the message, implantable device 108 can set up a secure connection with remote device 106. In another example, after receiving identification information for remote device 106 via NFC, NFC device 110 can transfer the identification information to implantable device 108. Implantable device 108 can then perform authentication/authorization processing of the identification information to determine whether implantable device 108 authorizes pairing with remote device 106. After authorization, implantable device 108 can set up a secure connection with remote device 106.

System 100 thus facilitates remote device pairing a device (e.g., remote device 106 and/or server 102) with an implantable device 108 via a simple and secure pairing protocol whereby remote device 106 does not need to communicate directly with implantable device 108 to initiate the pairing process. On the contrary, remote device 106 can initiate the pairing process by merely communicating with NFC device 110, such as an NFC tag, attached externally to the implantable device 108.

One benefit of system 100 is the ability to easily integrate NFC devices (e.g., NFC device 110) onto the external body of existing implantable devices. In addition, by placing an NFC device on an external body of the implantable device 108, (as opposed to placing an antenna required for NFC communication protocol on an external body of the implantable device while locating circuitry to facilitate NFC communication within the body of the implantable device), the NFC device/implantable device assembly does not require feed through circuitry (e.g., through an external body of the implantable device) to couple components located on an external body of the implantable device with components disposed within implantable device 108. Further, by locating a separate NFC device 110 on the outside body of an implantable device 108, additional external machine interface (EMI) protocol and other radio frequency (RF) entry points that can have an adverse effect on functions of implantable device 108 (e.g., sensing functions), regardless of whether the signal is intentional (e.g., desired NFC communications) or unintentional (e.g., interrupting/unwanted signals), can be reduced or even eliminated.

Furthermore, the use of NFC communication to facilitate pairing a remote device 106 with implantable device 108 is inherently secure due to the nature of NFC protocol. NFC protocol includes a set of short-range wireless technologies, typically requiring a distance of 4.0 centimeters (cm) or less. NFC operates at 13.56 MHz on ISO/IEC 18000-3 air interface and at rates ranging from 6.67 kilobits per second (kbit/s) to 848 kbit/s. Accordingly, in order to employ NFC protocol to pair implantable device 108 with a remote device, the two devices must be within close proximity of one another. Therefore, a person wearing an implantable device assembly (e.g., wherein the assembly includes implantable device 108 and NFC device 110) will closely interact (e.g., come face to face) with a reader device (or person operating a reader device) in order to allow pairing. As a result, if the wearer of the implantable device did not trust the reader device (e.g., or person employing the reader device), the wearer of the implantable device can prevent unauthorized pairing by merely moving away from the reader device.

One or more networks 104 can facilitate communications between the various devices (e.g., implantable device 108, NFC device 110, remote device 106 and server 102) of system 100. In an aspect, remote device 106 is configured to communicate with NFC device 110 and/or implantable device directly (e.g., without support of a network 104). In another aspect, remote device 106 is configured to communicate with implantable device over a network 104. In additional aspects, communications between remote device 106 and implantable device 108, remote device 106 and server 102, and/or server and implantable device 108, can employ various types of networks 104 as described below.

For example, after remote device 106 and implantable device 108 pair via NFC communication, remote device 106 and implantable device 108 can communicate using a different communications protocol (e.g., a communication protocol that is not NFC). According to this example, remote device 106 can communicate with implantable device 108 (and vice versa), using another type of communication protocol that may provide for communication over greater distances than NFC protocol or provide other advantages (such as increased security). Other communication protocol that can be employed by remote device 106 to communicate with implantable device 108 (and vice versa) can include but are not limited to, BLUETOOTH® technology based protocol (e.g., BTLE protocol), infrared data association (IrDA) protocol, ultra-wideband (UWB) standard protocol, radio frequency (RF) communication protocols, near-field inductive communication protocols, or other proprietary and non-proprietary communication protocols. In another example, remote device 106 can communicate with server 102 using LAN or a wide area network (WAN) such as the Internet. Accordingly, networks 104 can include various wired and wireless networks including but not limited to: cellular networks, wide area networks (WAD, e.g., the Internet), local area networks (LAN), and personal area networks (PAN).

NFC device 110 includes at least an antenna communicatively coupled to an integrated circuit, and a memory component that stores at least identification information (e.g., a number, a code, a key, a password, and etc.) identifying the implantable device 108 to which it is attached. This identification information can be used by remote device 106 to facilitate pairing between remote device 106 and implantable device 108.

In an aspect, NFC device 110 can store additional information (e.g., information aside from identification information required for pairing) that can be transferred to remote device 106 via NFC protocol, including but not limited to: a serial number of the implantable device, an identification of the implantable device type/model/manufacturer, a name of the implantable device, a date of implantation of the implantable device, and/or patient information (e.g., name age, date of birth, address, primary care physician name/number and etc.). For example, the NFC device 110 can store information that identifies an authentic device over a counterfeit device.

In some embodiments, information stored in memory of the NFC device 110 can be partitioned into different areas that can be restrictively accessed. According to this aspect, the NFC device 110 can require receipt of information from a remote device 106 (e.g., identification information, a password, a secret key, and etc.) prior to allowing access to some or all of the information stored in memory of the NFC device 110. For example, the NFC device 110 can store information that can be classified as non-secure and accessible to any remote device 106 (e.g. device brand or inventory number). In another example, NFC device 110 can require receipt of a password prior to transmitting certain secure information (e.g., patient information, identification information, and etc.). According to this example, the NFC device 110 can include a microprocessor to differentiate between requests for secure and non-secure information and verify information (e.g., password, secret key, code information), required to verify transmission of secure information to a remote device.

In an aspect, NFC device 110 is an NFC tag. According to this aspect, NFC device 110 is a passive, read-only device. In other aspect, the NFC device 110 can include a device or tag that can be written to once or multiple times. According to this aspect, the NFC devices 110 can be programmed during manufacture and/or even after implantation into a body (e.g., when attached to an implantable device). The write operation can be accomplished using a passkey or other secure method into an area where further write operations can be prevented unless the passkey is known.

In an aspect, when functioning as an NFC tag, NFC device 110 does not include a power source. Instead, NFC device 110 draws power from the device that reads it using magnetic induction. With respect to system 100, remote device 106 includes an NFC component configured to read identification information from NFC device 110. For example, in order to read and thus receive information from NFC device 110, the remote device 106 can move within close proximity (e.g., less than 4 cm.) of NFC device 110 and send a magnetic induction request signal to NFC device 110. The magnetic induction request signal is interpreted by NFC device 110 as a request to transmit information stored by NFC device 110. In response to the request signal, NFC device 110 becomes energized (e.g., by the magnetic field associated with the request signal) with enough energy to transmit the information stored therein to remote device 106.

In an aspect, NFC device 110 is encased in a biocompatible material. In one embodiment, the biocompatible material includes a liquid crystal polymer (LCP). However, the biocompatible material can include various additional known biocompatible materials. For example, the biocompatible material can include but is not limited to: a polyester polymer (e.g., LCP), a fluoropolymer (ethylene fluorinated ethylene propylene (EFEP)) (e.g., perfluoroalkoxy (PFA) or polytetrafluoroethylene (PTFE)) or a polyether ether ketone (PEEK).

In an aspect, NFC device 110 can include a magnetic shield disposed within the biocompatible material or outside of the biocompatible material. The magnetic shield can function to reduce or eliminate interference of magnetic induction signals received at NFC device 110 with the operations of implantable device 108 to which the NFC device is attached. The magnetic shield can be sandwiched between NFC device 110 and implantable device 108 when NFC device 110 is attached or laminated to implantable device 108. The magnetic shield can include any suitable material configured to prevent leakage/interruption of magnetic induction signals from NFC device 110 (e.g., when the NFC device is being read by remote device 106) to implantable device 108 to which it is attached. In one embodiment, the magnetic shield includes ferrite.

Implantable device 108 can represent various types of implantable devices, including implantable medical devices. The particular, size, shape, placement and function of implantable device 108 is not critical to the subject disclosure. Example implantable devices include implantable cardiac pacemakers, cardiac defibrillators, cardioverter defibrillators, cardiac resynchronization devices, cardiac monitoring devices, cardiac pressure monitoring devices, spinal stimulation devices, brain stimulation devices, gastric stimulation devices, diabetes pumps, or any other medical devices. However, implantable devices described herein, such as implantable device 108, include at least a housing and a device circuit located within the housing. In an aspect, the device circuit is formed on or within a substrate that is placed inside a biocompatible housing. The device circuit can include at least a communication component configured to communicate with remote device 106 and/or server 102 and one or more power sources. An example implantable device 108 that can be employed by system 100 is described in greater detail infra with respect to FIG. 8.

Remote device 106 can include any suitable computing device configured to interact with NFC device 110, using NFC protocol, and implantable device 108 using NFC protocol or another wireless communication protocol. For example, remote device 106 can include a reader device configured to read information from NFC device 110 and implantable device 108. Remote device 106 can also include a programming device configured to program implantable device 108. Remote device 106 can further include devices configured to communicate with one or more additional devices (e.g., server 102) over the various networks 104 described herein. For example, remote device 106 can include but is not limited to, a handheld computing device, a desktop computer, a laptop computer, a smart-phone, a tablet personal computer (PC), a personal digital assistant (PDA) or a server. An example remote device 106 that can be employed by system 100 is described in greater detail infra with respect to FIG. 9.

Referring now to FIG. 2, presented is a diagram 200 demonstrating an example pairing process between remote device 210 and implantable device 202 using a server 212 in accordance with aspects described herein. In diagram 200, remote device 210 functions as a proxy for establishing a secure communication channel between implantable device 202 and server 212. In various aspects, server 102, remote device 106, implantable device 108 and NFC device 110 can include one or more of the structure and/or functionality of server 212, remote device 210, implantable device 202 and NFC device 204 (and vice versa). Repetitive description of like elements employed in respective embodiments of systems and devices described herein are omitted for sake of brevity.

Diagram 200 includes implantable device 202, NFC device 204, externally attached to implantable device 202, remote device 210 and server 212. Implantable device 202 and NFC device 204 include respective communication components 208 and 206. In an aspect, communication component 206 includes an antenna and that is configured to communicate with another device via NFC protocol. Communication component 208 can also include an antenna. Communication component 208 can be configured to communicate with another device (e.g., remote device 210, server 212 and/or another device), using wireless communication techniques other than NFC. These wireless communication techniques may, in some instances, communicate over greater distances than NFC protocol. For example, communication component 208 can communicate with remote device 210 using BLUETOOTH® technology, radio frequency (RF) communications, inductive communications, tissue conductance communication, or other form of communication including both proprietary and non-proprietary communications. Remote device 210 can also include a communication component (not shown) configured to communicate with communication component 206 and communication component 208 as well as server 212.

The pairing process between implantable device 202 and remote device 210 is exemplified by acts (1), (2), and (3). The pairing of implantable device 202 with remote device 210 merely functions to set up a secure communication channel between implantable device 202 and server 212 whereby remote device 210 operates as proxy for establishment of a secure channel between implantable device 202 and server 212. The pairing process begins at act (1) wherein the remote device 210 interacts with NFC device 204 to receive identification information stored by the NFC device 204. For example, remote device 210 can move within close proximity of NFC device 204 and send a request induction signal that is received by communication component 206 (e.g., an NFC induction coil antenna). The request induction signal can energize the NFC device, causing the NFC device to transmit identification information stored therein back to remote device 210 using NFC protocol.

Once remote device 210 receives the identification information, remote device 210 can proceed to determine whether the remote device can communicate with the implantable device communication component 208 without establishing a secure channel. If the remote device 210 cannot communicate with communication component 208 without a secure channel, the remote device 210 can pass the identification received from the NFC device 204 onto the server 212 to receive authorization to pair with implantable device 202. In particular, as depicted by act (2) of diagram 200, remote device 210 can communicate the identification information to the server 212 to facilitate authenticating and authorizing a pairing between implantable device 202 and remote device 210. For example, server 212 can determine that a pairing between remote device 210 and implantable device 202 is authorized and send a message or signal (e.g., a key or password) back to the remote device indicating this authorization. In an aspect, communications between remote device 210 and server 212 are facilitated over a LAN or PAN. For example, remote device 210 can communicate with server and vice versa using a browser installed thereon that employs hypertext transfer protocol.

At act (3) once authorization is received, remote device 210 can establish a secure connection with implantable device 202 via communication component 208. For example, remote device 210 can send the authorization message or signal to implantable device 202 that allows implantable device 202. The implantable device can then authenticate the authorization message or signal (e.g., perform a key matching procedure) and open up communication with remote device 210 (e.g., communication of sensitive information over a secure data channel). In an aspect, communication between remote device 210 and implantable device 202 via communication component 208 is performed using a LAN (not including NFC protocol). For example, communications between remote device 210 and implantable device 208 can include but are not limited to: BLUETOOTH® technology based protocol (e.g., BLUETOOTH® low energy (BTLE) protocol), infrared data association (IrDA) protocol, and ultra-wideband (UWB) standard protocol, radio frequency (RF) communication protocols or other proprietary and non-proprietary communication protocols.

Referring now to FIG. 3, presented is an example NFC device 300 in accordance with aspects described herein. In various aspects, NFC device 300 can include one or more of the structure and/or functionality of NFC device 110 and 204 (and vice versa). Repetitive description of like elements employed in respective embodiments of devices and systems described herein are omitted for sake of brevity. NFC device 300 is configured to store information associated with an implantable device (e.g., identification information, serial number, implantable device name, patient information, and etc.) and transmit the information to another device using NFC protocol.

NFC device 300 can include a housing 302 and an integrated circuit 304 and antennal 306. Housing 302 can include at least a biocompatible material that encases integrated circuit 304 and antenna 306. In aspect, (not shown) antenna can be located outside of housing 302. Housing 302 is configured to attach to an implantable device. In an aspect, NFC device 300 is an NFC tag configured to laminate, or otherwise permanently adhere to an implantable device. Integrated circuit 304 (or chip) can include circuitry 308 and memory 312. Antennal 306 is communicatively coupled to integrated circuit 304. Memory 312 can store information that is to be transmitted to another device via antenna 306 using NFC protocol. According to this embodiment, NFC device 300 does not require a power source to operate. In particular, circuitry 308 is configured to employ an induction signal received by antenna 306 and convert the induction signal into enough energy to retrieve information stored in memory 312 and transmit the information to the external device providing the induction signal.

FIGS. 4-7 present example embodiments of implantable device assemblies configured to be implanted into a body (e.g., a human body) in accordance with aspects described herein. In various aspects, NFC devices of FIGS. 4-7 can include one or more of the structure and/or functionality of NFC device 110 and 204 (and vice versa). Repetitive description of like elements employed in respective embodiments of devices and systems described herein are omitted for sake of brevity. It should be appreciated that the size and shape of the devices and device assemblies described herein are not critical to the subject disclosure. For example, although devices and device assemblies are depicted as rectangular prisms, the devices and device assemblies can have any desirable shape (e.g., round, oval, cylindrical, or irregular). In an aspect, the NFC devices described herein can have a size and shape that facilitates attaching to an implantable device. Thus in an aspect, the size and shape of an NFC device and an implantable device, when combined in an implantable device assembly as described herein, can complement one another.

With reference initially to FIG. 4, implantable device assembly 400 includes NFC device 402 attached to implantable device 412. NFC device 402 can affix to implantable device 412 using various known attachment mechanisms, including an adhesive (e.g., silicone or a pressure sensitive adhesive (PSA)). NFC device 402 includes antenna 404 and integrated circuit 406. Integrated circuit 406 and antenna 404 are operatively coupled. Integrated circuit 406 can include memory having information stored therein (e.g., identification information) and circuitry that facilitates transmitting the information to an external device via antenna 404. In an aspect, as shown in FIG. 4, antenna 404 and integrated circuit 406 can be formed on substrate 408. The substrate can include various suitable materials, including a liquid crystal polymer, polyimide, polyester, FR4 and etc. Substrate 408, antenna 404 and integrated circuit 406 can further be encased in a biocompatible housing 410. The biocompatible housing 410 can include an insulating material (e.g., a non-conductive and non-magnetic material). The thickness of the biocompatible housing 410 can vary and is dependent on the material used and expected device longevity. In an example, where the biocompatible housing includes glass, the thickness can be about 25.0 μm. In another aspect, where the material includes LCP, the thickness can be about 100 μm.

Antenna 404 is configured to transmit and receive signals using NFC protocol. Antenna 404 and integrated circuit 406 can have any suitable size and shape. Antenna 404 and integrated circuit 406 are depicted having a rectangular shape merely for exemplary purposes. For example, antenna 404 can include a circular shape that encompasses the perimeter area of the NFC device or a coil shape that facilitates magnetic induction NFC communications. In an aspect, as seen in FIG. 400, the antenna 404 is larger than the integrated circuit 406. In an example, the antenna 404 can circle around the integrated circuit 406. However in other aspects, the antenna 404 may be smaller than the integrated circuit. In some aspects, the integrated circuit 406 can be arranged an outside edge of the antenna. In other scenarios the antenna 404 can include a tuning cap. For example, the tuning cap can be a part of a substrate (discussed infra) on which integrated circuit 406 is formed or disassociated from the substrate.

FIG. 5 presents another embodiment of implantable device assembly 500 in accordance with aspects described herein. Implantable device assembly 500 is similar to implantable device assembly 400 with the addition of magnetic shield 502. In an aspect, the magnetic shield includes ferrite, but other materials are contemplated.

As seen in FIG. 5, NFC device 402 includes magnetic shield 502 adjacent to and below substrate 408. Magnetic shield 502 is further encased within biocompatible housing 410. Implantable device assembly 500 is constructed so that magnetic shield 502 of NFC device 402 is sandwiched between substrate 408 and implantable device 412 (e.g., magnetic shield 502 is adjacent to implantable device 412 and between implantable device and antenna 404/integrated circuit 406). In an aspect, antenna 404 and integrated circuit 406 can be formed directly on magnetic shield 502. According to this aspect, NFC device 402 does not employ substrate 408.

FIG. 6 presents another embodiment of implantable device assembly 600 in accordance with aspects described herein. Implantable device assembly 600 is similar to implantable device assembly 500 aside from the location of the magnetic shield 502. According to this embodiment, magnetic shield 502 is located outside of biocompatible housing 410. When NFC device 402 and implantable device 412 are separated, magnetic shield 502 can be attached to either NFC device 402 or implantable device 412. When NFC device 402 and implantable device 412 come together to form implantable device assembly 500, magnetic shield 502 is however sandwiched between substrate 408 and implantable device 412 (e.g., magnetic shield 502 is adjacent to implantable device 412 and between implantable device and antenna 404/integrated circuit 406).

FIG. 7 presents yet another embodiment of implantable device assembly 700 in accordance with aspects described herein. Implantable device assembly 700 is similar to implantable device assembly 600. However with implantable device assembly 700, biocompatible housing 410 encases both NFC device 402 and implantable device 412.

Referring now to FIG. 8, presented is an example embodiment of implantable device 800 in accordance with aspects described herein. In various aspects, implantable device 800 can include one or more of the structure and/or functionality of implantable device 108 and 202 (and vice versa). Repetitive description of like elements employed in respective embodiments of devices and systems described herein are omitted for sake of brevity.

Aspects of devices, (e.g., implantable device 800) apparatus and systems herein can constitute machine-executable components embodied within one or more machines (e.g., embodied in one or more computer-readable storage media associated with one or more machines). Such components, when executed by the one or more machines (e.g., processors, computers, computing devices, virtual machines, etc.) can cause the one or more machine to perform the operations described. Implantable device 800 can include memory 812 for storing computer-executable components and instructions. Processor 810 can facilitate operation of the computer-executable components and instructions by implantable device 800.

Implantable device 800 can include various types, sizes, and shapes of devices. In an aspect, implantable device 800 is an implantable medical device. Implantable device 800 includes housing 802 and device circuit 804 disposed on or within housing 802. Housing 802 can include various materials. Housing 802 can include a conductive material, such as metal or metal alloy, a non-conductive material such as glass, plastic, ceramic, etc., or a combination of conductive and non-conductive materials. In an aspect, housing 802 includes a biocompatible material (e.g., LCP) that encases device circuit 804. Device circuit 804 can include various communicatively coupled components 806-818 that facilitate operation of implantable device 800. Is should be appreciated that various components 806-818 of device circuit 804 can be provided at disparate locations within device housing and are not limited to placement on a single integrated circuit. For example, device circuit 804 can include two or more communicatively coupled chips.

Device circuit 804 can include one or more power sources 806 that provide power for operation of implantable device 800 and power circuitry 808 that facilitates providing power to various implantable device components 806-818. A power source 806 can include any suitable power source that can provide necessary power for operation of various components of implantable device 800. For example, power source 806 can include but is not limited to a battery, a capacitor, a charge pump, a mechanically derived power source (e.g., microelectromechanical systems (MEMs) device), or an induction component. In an aspect, power source 806 includes a rechargeable power source. For example, power source 806 can include an induction component configured to receive energy via wireless energy transfer (e.g., using electromagnetic inductance techniques and related components). The received energy can further be employed to provide power to implantable device 800 components and/or recharge another power source 806 (e.g., a battery) of implantable device 800.

Implantable device 800 further includes communication component 814, authorization component 816 and one or more sensor 818. Communication component 814 is configured to communicate with a remote device (e.g., remote device 106 or other external device). Communication component 814 can include a transmitter configured to transmit data to a remote device, a receiver configured to receive data from a remote device, and/or a transceiver configured to transmit and receive data to and from a remote device. Communication component 814 can be configured to communicate with a remote device using various short range and/or long range radio frequency (RF) communication protocols. For example, communication component 814 can include an RF transceiver (e.g., an antenna) configured to communicate with a remote device using BLUETOOTH® technology based protocol (e.g., BLUETOOTH® low energy (BTLE) protocol), infrared data association (IrDA) protocol, and ultra-wideband (UWB) standard protocol, radio frequency (RF) communication protocols, near-field inductive communication protocols, or other proprietary and non-proprietary communication protocols.

In an aspect, communication component 814 is restricted regarding the type of information that it can transmit and/or receive to and from a remote device as a function of establishment of a secure pairing with the remote device. According to this aspect, some or all communications to and/or from implantable device 800 can be enabled/disabled as a function of a secure pairing of implantable device 800 with a remote device. For example, implantable device 800 can store data in memory 812 and/or receive data from one or more sensors 818 that can be transmitted to a remote device. This information can include sensitive or confidential information that should only be accessed by a trusted device as well as non-sensitive information that may be accessed by a non-trusted device. In another example, a remote device can transmit information, such as programming information, to implantable device 800 that effects operation of the implantable device. According to this example, a control device could program an implanted medical device to release a drug a prescribed dosage. This type of programming communication should only be enabled by authorized devices (e.g., devices operated by an authorized medial professional).

Accordingly, in an aspect, communication component 814 is configured to transmit and/or receive information to and from implantable device 800 only after establishment of a secure connection with a remote device. In another aspect, communication component 814 is configured to transmit and/or receive a first class or type of information (e.g., information considered non-sensitive) to and/or from implantable device 800 without the establishment of a secure pairing with another device, and a second class or type of information (e.g., information considered sensitive) in response to establishment of a secure pairing with another device.

Authorization component 816 is configured to facilitate establishment of a secure pairing of implantable device 800 with a remote device based in part on identification information for the implantable device transmitted to the remote device via an NFC device (e.g., NFC device 110, 204, 300 and etc.) associated with implantable device 800. Authorization component 816 can further enable/disable communication of information as a function of a secure pairing of implantable device 800 with another device and/or as a function of the type of information to be transmitted and/or received to and from implantable device 800.

For example, authorization component 816 can receive a signal from a remote device requesting to pair with implantable device 800. The signal can include information indicating that the remote device has been authorized (e.g., by an external authorization system) to pair with implantable device, where authorization is based at least in part on identification information for the implantable device 800 transmitted to the remote device via an NFC device associated with the remote device. In response to the received authorization signal, the authorization component 816 can then enable communications to and/or from implantable device 800.

In another aspect, the signal can include a key or password provided by a remote device. The key or password can be generated and provided to the remote device by a server (e.g., in association with authenticating and authorizing NFC tag identification information for the implantable device 800). The authorization component 816 can further perform a key matching procedure using the key (and another key stored in memory 812) to determine whether the implantable device 800 is authorized to pair with the remote device. If authorized based on the key matching procedure, the authorization component 816 can allow the communication component 814 to communicate with the remote device (e.g. using a BLUETOOTH® protocol).

Referring now to FIG. 9, presented is an example embodiment of remote device 900 capable of pairing with an implantable device using an NFC tag associated with the implantable device in accordance with aspects described herein. In various aspects, remote device 900 can include one or more of the structure and/or functionality of remote device 106 and 210 (and vice versa). Repetitive description of like elements employed in respective embodiments of devices and systems described herein are omitted for sake of brevity.

Remote device 900 can include one or more power sources 902 that provide power for operation of remote device 900 and power circuitry 904 that facilitates providing power to various device components. Remote device 900 also includes memory 908 for storing computer-executable components and instructions. Processor 906 can facilitate operation of the computer-executable components and instructions by remote device 900. Remote device 900 further includes communication component 910, authorization component 914, display component 916 and programming component 918.

Communication component 910 and authorization component 914 can include one or more of the structure and/or functionality of communication component 814 and authorization component 816, respectively. Communication component 910 can further include NFC component 912. NFC component is configured to communicate with another device using NFC protocol. In an aspect, NFC component 912 is configured to communicate with an NFC device (e.g., NFC device 110, 204, 300 and the like) that is attached to an implantable device to request and receive information stored at the NFC device. For example, NFC component 912 can include an NFC antenna configured to transmit a request induction signal to an NFC device attached to an implantable device. The request signal can include a request for information stored on the NFC device. The request signal can include an induction current that generates a response current in an induction coil/antenna of the NFC device. The response current at the induction coil/antenna of the NFC device is employed by the NFC device to power transmission of information (e.g., implantable device identification information) stored at the NFC device to remote device 900.

In an aspect, remote device 900 employs communication component 910 to communicate with an NFC device attached to an implantable device, an external device (e.g., an external server), and/or an implantable device. As noted above, communication component 910 can employ NFC protocol to communicate with an NFC device attached to an implantable device. Communication component 910 can also employ NFC protocol to communicate with an implantable device. In addition, communication component 910 can communicate with an implantable device using another type of communication protocol over PAN or a local area network (LAN), (e.g., a wireless fidelity network) that may provide for communication over greater distances than NFC protocol or provide other advantages (such as increased security). Other communication protocols that can be employed by communication component 910 to communicate with an implantable device can include but are not limited to, BLUETOOTH® technology based protocol (e.g., BLUETOOTH® low energy (BTLE) protocol), infrared data association (IrDA) protocol, and ultra-wideband (UWB) standard protocol, radio frequency (RF) communication protocols, or other proprietary and non-proprietary communication protocols. Communication component can also communicate with other remote devices (e.g., server) over a WAN using cellular or HTTP based communication protocols.

Authorization component 914 is configured to facilitate pairing remote device 900 with an implantable device (e.g., implantable device 800), based at least in part on identification information for the implantable device as received at NFC component 912 from an NFC device attached to the implantable device. In an aspect, authorization component 914 can employ an external server to perform authentication of the identification information and authorization of a pairing between remote device 900 and the implantable device. For example, authorization component 914 can send identification information received via an NFC tag attached to an implantable device to an external server. The external server can further determine whether the remote device 900 is authorized to pair with the implantable device based on the identification information. The external server can in turn, send a message (e.g., password or private key) to the remote device 900 that can be employed by the remote device to set up a secure communication channel with the implantable device.

In an aspect, after authorization component 914 has received a message that remote device 900 is authorized to pair with an implantable device from an external server, authorization component 914 can send (e.g., using communication component 910) an authorization message to the implantable device. The authorization message can include a signal that informs an authorization component of the implantable device (e.g., authorization component 816) that remote device 900 and the implantable device are authorized to communicate via a secure data channel. In turn, communication component 910 can begin transmitting and/or receiving information to and from the implantable device (e.g., using RF, BLUETOOTH®, NFC and/or other PAN or LAN type of communication protocols).

In another aspect, authorization component 914 is configured to perform an authentication/authorization mechanism using identification information received from an NFC device attached to an implantable device to determine if the remote device 900 is authorized to pair with the implantable device. In one or more embodiments, authorization component 914 can perform this authentication/authorization process without communicating with an external server (e.g., server 102) as discussed with respect to FIG. 1. For example, the authorization component 914 can receive authentication input from a patient wearing an implantable device and/or an administrator of remote device 900. The authorization component 914 can employ techniques to verify the authentication information. In response to verification the authorization component 914 can allow NFC communication between remote device 900 and an NFC device attached to an implantable device.

Remote device 900 can also include display component 916 to display information to a user. For example, display component 916 can display instructions to be transmitted to an implantable device and/or information received from an implantable device. In an aspect, remote device 900 is employed merely as a reader device to receive information from an implantable device. In another aspect, remote device 900 can be employed as a programming device. According to this aspect, remote device 900 can include programming component 918 to configure and send (e.g., using communication component 910) control data to the implantable device.

In view of the example systems and/or devices described herein, example methods that can be implemented in accordance with the disclosed subject matter can be further appreciated with reference to flowcharts in FIGS. 10-12. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 10 illustrates a flow chart of an example method 1000 for paring an implantable device with a remote device using an NFC component attached to the implantable device. At 1002, a request to pair a remote device with an implantable device is received at a near field communication NFC component attached to the implantable device. At 1004, identification information associated with the implantable device is transmitted to the remote device in response to the request using NFC protocol. With the subject method, a remote device can pair with an implantable device via a simple and secure pairing protocol without communicating directly with the implantable device to perform the pairing process. On the contrary, the remote device can initiate the pairing process by merely communicating with an NFC component, such as an NFC tag, attached externally to the implantable device.

FIG. 11 illustrates a flow chart of another example method 1100 for paring an implantable device with a remote device using an NFC component attached to the implantable device. At 1102, a request to pair a remote device with an implantable device is received at a near field communication NFC component attached to the implantable device. At 1104, identification information associated with the implantable device is transmitted to the remote device in response to the request using NFC protocol. At 1106, an authorization signal is received from the remote device at the implantable device based in part on authentication and authorization of the identification information. At 1108, the implantable device can communicate information with the remote device in response to the received authorization signal.

FIG. 12 illustrates a flow chart of an example method 1200 for paring a remote device with an implantable device using an NFC component attached to the implantable device. At 1202, a request to pair with an implantable device is transmitted using a first communication protocol, wherein the first communication protocol includes an NFC protocol. At 1204, identification information associated with the implantable device is received in response to the request. At 1206, a determination is made as to whether the device is authorized to pair with the implantable device based in part on the identification information. At 1208, the device can begin communicating with the implantable device using a second communication protocol different from the first communication protocol in response to a determination that the device is authorized to pair with the implantable device.

Some of the embodiments described herein can be practiced in computing environments and/or in collaboration with computing environments. In these environments, certain tasks can be performed by remote processing devices that are linked through a communications network. Also, some of the embodiments include computing devices having computer-executable instructions that can be executed by processors to perform one or more different functions. Those skilled in the art will recognize that the embodiments can be also implemented in combination with hardware and/or software.

FIG. 13 illustrates a block diagram of a computer operable to facilitate paring an implantable device with a remote device in accordance with aspects described herein. For example, in some embodiments, the computer can be or be included within implantable device 108, 202, 412, or 802, remote device 106, 210, or 900, server 102 or 212 and/or any components of the systems (e.g., system 100 and the like) described herein.

In order to provide additional context for various embodiments described herein, FIG. 13 and the following discussion are intended to provide a brief, general description of suitable computing environment 1300 in which the various embodiments described herein can be implemented.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data or unstructured data. Tangible and/or non-transitory computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage, other magnetic storage devices and/or other media that can be used to store desired information. Computer-readable storage media can be accessed by one or more local or remote computing devices, e.g., via access requests, queries or other data retrieval protocols, for a variety of operations with respect to the information stored by the medium.

In this regard, the term “tangible” herein as applied to storage, memory, computer-readable media or computer-readable storage media, is to be understood to exclude only propagating intangible signals per se as a modifier and does not relinquish coverage of all standard storage, memory, computer-readable media or computer-readable storage media that are not only propagating intangible signals per se.

In this regard, the term “non-transitory” herein as applied to storage, memory, computer-readable media or computer-readable storage media, is to be understood to exclude only propagating transitory signals per se as a modifier and does not relinquish coverage of all standard storage, memory, computer-readable media or computer-readable storage media that are not only propagating transitory signals per se.

Communications media typically embody computer-readable instructions, data structures, program modules or other structured or unstructured data in a data signal such as a modulated data signal, e.g., a channel wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, example environment 1300 for implementing various aspects of the embodiments described herein includes computer 1302, computer 1302 including processing unit 1304, system memory 1306 and system bus 1308. System bus 1308 couples system components including, but not limited to, system memory 1306 to processing unit 1304. Processing unit 1304 can be any of various commercially available processors. Dual microprocessors and other multi-processor architectures can also be employed as processing unit 1304.

System bus 1308 can be any of several types of bus structure that can further interconnect to a memory bus (with or without a memory controller), a peripheral bus, and a local bus using any of a variety of commercially available bus architectures. System memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within computer 1302, such as during startup. RAM 1312 can also include a high-speed RAM such as static RAM for caching data.

Computer 1302 further includes internal hard disk drive (HDD) 1314 (e.g., Enhanced Integrated Drive Electronics (EIDE), Serial Advanced Technology Attachment (SATA)). HDD 1314 can be connected to system bus 1308 by hard disk drive interface 1204. The drives and their associated computer-readable storage media provide nonvolatile storage of data, data structures, computer-executable instructions, and so forth. For computer 1302, the drives and storage media accommodate the storage of any data in a suitable digital format.

A number of program modules can be stored in the drives and RAM 1312, including operating system 1330, one or more application programs 1332, other program modules 1334 and program data 1336. All or portions of the operating system, applications, modules, and/or data can also be cached in RAM 1312. The systems and methods described herein can be implemented utilizing various commercially available operating systems or combinations of operating systems.

A mobile device can enter commands and information into computer 1302 through one or more wireless input devices, e.g., wireless keyboard 1338 and a pointing device, such as wireless mouse 1340. Other input devices (not shown) can include a smart phone, tablet, laptop, wand, wearable device or the like. These and other input devices are often connected to the processing unit 1304 through input device interface 1342 that can be coupled to system bus 1308, but can be connected by other interfaces, such as a parallel port, an IEEE 1394 serial port, a game port and/or a universal serial bus (USB) port.

Computer 1302 can operate in a networked environment using logical connections via wired and/or wireless communications to one or more remote computers, such as remote computer(s) 1348. Remote computer(s) 1348 can be a workstation, a server computer, a router, a personal computer, portable computer, microprocessor-based entertainment appliance, a peer device or other common network node, and typically includes many or all of the elements described relative to computer 1302, although, for purposes of brevity, only memory/storage device 1350 is illustrated. The logical connections depicted include wired/wireless connectivity to local area network (LAN) 1352 and/or larger networks, e.g., a wide area network (WAN) 1354. Such LAN and WAN networking environments are commonplace in offices (e.g., medical facility offices, hospital offices) and companies, and facilitate enterprise-wide computer networks, such as intranets, all of which can connect to a global communications network (e.g., the Internet).

When used in a LAN networking environment, computer 1302 can be connected to local network 1352 through a wired and/or wireless communication network interface or adapter 1356. Adapter 1356 can facilitate wired or wireless communication to LAN 1352, which can also include a wireless AP disposed thereon for communicating with wireless adapter 1356.

When used in a WAN networking environment, computer 1302 can include modem 1358 or can be connected to a communications server on WAN 1354 or has other means for establishing communications over WAN 1354, such as by way of the Internet. Modem 1358, which can be internal or external and a wired or wireless device, can be connected to system bus 1308 via input device interface 1342. In a networked environment, program modules depicted relative to computer 1302 or portions thereof, can be stored in remote memory/storage device 1350. It will be appreciated that the network connections shown are example and other means of establishing a communications link between the computers can be used.

Computer 1302 can be operable to communicate with any wireless devices or entities operatively disposed in wireless communication. This can include NFC, Wireless Fidelity (Wi-Fi) and BLUETOOTH® wireless technologies. Thus, the communication can be a defined structure as with a conventional network or simply an ad hoc communication between at least two devices. NFC technologies typically

NFC can allow point-to-point connection to an NFC-enabled device in the NFC field of an IMD within the home or at any location. NFC technology can be facilitated using an NFC-enabled smart phone, tablet or other device that can be brought within 3-4 centimeters of an implanted NFC component. NFC typically provides a maximum data rate of 424 Kbps, although data rates can range from 6.67 Kbps to 828 Kbps. NFC typically operates at the frequency of 13.56 MHz. NFC technology communication is typically over a range not exceeding 0.2 m and setup time is less than 0.1 second (s). Low power (e.g., 15 mA) reading of data can be performed by an NFC device.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out. Wi-Fi networks use radio technologies called IEEE 802.11(a, b, g, n, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands, at an 11 Mbps (802.11a) or 54 Mbps (802.11b) data rate, for example or with products that contain both bands (dual band), so the networks can provide real-world performance similar to the basic 10BaseT wired Ethernet networks used in many offices.

The embodiments of devices described herein can employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of an acquired network. A classifier is a function that maps an input attribute vector, x=(x1, x2, x3, x4, . . . , xn), to a confidence that the input belongs to a class, that is, f(x)=confidence(class). Such classification can employ a probabilistic and/or statistical-based analysis (e.g., factoring into the analysis utilities and costs) to prognose or infer an action that a mobile device desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing mobile device behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to a predetermined criteria which of the acquired cell sites will benefit a maximum number of subscribers and/or which of the acquired cell sites will add minimum value to the existing communication network coverage, etc.

As employed herein, the term “processor” can refer to substantially any computing processing unit or device including, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of mobile device equipment. A processor can also be implemented as a combination of computing processing units.

Memory disclosed herein can include volatile memory or nonvolatile memory or can include both volatile and nonvolatile memory. By way of illustration, and not limitation, nonvolatile memory can include ROM, programmable ROM (PROM), electrically programmable ROM (EPROM), electrically erasable PROM (EEPROM) or flash memory. Volatile memory can include RAM, which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data storages, databases) of the embodiments are intended to include, without being limited to, these and any other suitable types of memory.

As used herein, terms such as “data storage,” “database,” and substantially any other information storage component relevant to operation and functionality of a component, refer to “memory components,” or entities embodied in a “memory” or components including the memory. It will be appreciated that the memory components or computer-readable storage media, described herein can be either volatile memory or nonvolatile memory or can include both volatile and nonvolatile memory.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word “example” or “exemplary” is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application should generally be construed to mean “one or more” unless specified otherwise or clear from context to be directed to a singular form. The terms “first,” “second,” “third,” and so forth, as used in the claims and description, unless otherwise clear by context, is for clarity only and doesn't necessarily indicate or imply any order in time.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the detailed description and the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An implantable device assembly, comprising:
an implantable device; and
a near field communication (NFC) component externally attached to the implantable device and configured to transmit identification information associated with the implantable device to a reader device using NFC protocol, wherein transmission is in response to a received request signal.

2. The implantable device assembly of claim 1, wherein the implantable device is configured to pair with the reader device based in part on transmission of the identification information by the NFC component.

3. The implantable device assembly of claim 1, wherein the request signal comprises an induction signal received from the reader using NFC protocol.

4. The implantable device assembly of claim 1, wherein the implantable device is hermetically sealed.

5. The implantable device assembly of claim 1, wherein the NFC component comprises at least one of, a read-only, passive NFC tag or an NFC tag configured to be written to one or more times.

6. The implantable device assembly of claim 1, wherein the NFC component comprises:
an integrated circuit;
an antenna; and
a memory component configured to store the identification information.

7. The implantable device assembly of claim 6, wherein the NFC component further comprises a ferrite shield.

8. The implantable device assembly of claim 1, wherein the NFC component is encased in biocompatible material.

9. The implantable device assembly of claim 8, wherein the biocompatible material comprises a liquid crystal polymer.

10. The implantable device assembly of claim 1, wherein the NFC component is separated from the implantable device by a ferrite shield.

11. The implantable assembly of claim 1, wherein the identification information comprises at least one of: a unique authentication number associated with the implantable device, a serial number of the implantable device, an identification of the implantable device type or a name of the implantable device.

12. The implantable device assembly of claim 1, wherein the identification information comprises information that facilitates determining whether a device is authentic, unauthorized, or a counterfeit.

13. The implantable device assembly of claim 3, wherein the NFC component is configured to receive power based, at least, on receipt of the request signal, and wherein transmission of the identification information is in response to receipt of power.

14. The implantable device assembly of claim 1, wherein the implantable device comprises:
a computer-readable storage medium storing computer-executable components;
a processor configured to execute the computer-executable components;
an authorization component configured to receive an authorization signal from the reader device based, in part, on authentication of the identification information; and
a communication component configured to communicate information with the reader device in response to receipt of the authorization signal.

15. The implantable device assembly of claim 14, wherein the communication component is further configured to communicate the information using a BLUETOOTH® low energy (BTLE) protocol.

16. An apparatus, comprising:
a biocompatible housing coupleable to an implantable medical device; and
an integrated circuit disposed within the biocompatible housing, wherein the integrated circuit comprises:
a computer-readable storage medium configured to store identification information associated with the implantable medical device; and
an antenna configured to transmit the identification information to a reader device using a near field communication (NFC) protocol in response to a request signal.

17. The apparatus of claim 16, wherein the request signal is an induction signal and the antenna is further configured to receive power based, at least, on receipt of the induction signal.

18. The apparatus of claim 16, wherein the biocompatible housing comprises a liquid crystal polymer material.

19. The apparatus of claim 16, further comprising a ferrite shield disposed on or within the biocompatible housing.

20. A method, comprising:
receiving, at a near field communication (NFC) component attached to an implantable device, a request to pair a remote device with the implantable device; and
transmitting, by the NFC component, to the remote device, identification information associated with the implantable device, wherein the transmitting is in response to the request, and wherein the transmitting is performed using NFC protocol.

21. The method of claim 20, further comprising, pairing the implantable device with the remote device based, in part, on the transmitting the identification information.

22. The method of claim 20, wherein the receiving the request includes receiving induction energy, the method further comprising:
powering, using the induction energy, the NFC component to perform the transmitting.

23. The method of claim 20, further comprising:
receiving, at the implantable device, an authorization signal from the remote device based, in part, on authentication of the identification information; and
communicating, by the implantable device, information with the remote device in response to the receiving the authorization signal.

24. The method of claim 23, wherein the communicating the information comprises communicating the information using a BLUETOOTH® low energy (BTLE) protocol.

25. A device, comprising:
a computer-readable storage medium storing computer-executable components;
a processor configured to execute the computer-executable components;
a near field communication component (NFC) configured to transmit a request to pair with an implantable device using a first communication protocol and receive identification information associated with the implantable device in response to the request, wherein the first communication protocol comprises an NFC protocol;
an authorization component configured to determine if the device is authorized to pair with the implantable device based, in part, on the identification information; and
a primary communication component configured to communicate with the implantable device using a second communication protocol different from the first communication protocol in response to a determination that the device is authorized to pair with the implantable device.

26. The device of claim 25, wherein the NFC component is further configured to provide induction energy to an NFC tag attached to the implantable device associated with the request, wherein the NFC component is further configured to receive the identification information based on receipt of the induction energy.

27. The device of claim 25, wherein the primary communication component is further configured to communicate an authorization signal to the implantable device in response to a determination that the device is authorized to pair with the implantable device.

28. The device of claim 25, wherein the second communication protocol comprises a BLUETOOTH® low energy (BTLE) protocol.

29. The device of claim 25, wherein the authorization component is further configured to employ an external server to determine if the device is authorized to pair with the implantable device based, in part, on the identification information.

30. A method, comprising:
transmitting a request to pair with an implantable device using a first communication protocol, wherein the first communication protocol comprises an NFC protocol;
receiving identification information associated with the implantable device in response to the request;
determining if the device is authorized to pair with the implantable device based, in part, on the identification information; and
communicating with the implantable device using a second communication protocol different from the first communication protocol in response to a determination that the device is authorized to pair with the implantable device.

31. The method of claim 30, further comprising:
providing induction energy to an NFC tag attached to the implantable device associated with the request; and
receiving the identification information based on receipt of the induction energy.

32. The method of claim 30, further comprising:
communicating an authorization signal to the implantable device in response to a determination that the device is authorized to pair with the implantable device, wherein the communicating with the implantable device using the second communication protocol is based on the authorization signal.

33. The method of claim 30, wherein the communicating with the implantable device using the second communication protocol comprises using a BLUETOOTH® low energy (BTLE) protocol.

34. The method of claim 30, wherein the determining if the device is authorized to pair with the implantable device comprises employing an external server.
